(19) United States
(12) Patent Application Publication
(10) Pub. No.: US 2015/0348174 A1
(43) Pub. Date: Dec. 3, 2015

(54) SYSTEM AND METHOD FOR DIGITAL CAPTURING, PROCESSING AND APPLICATION OF PRINTS TO CONSUMER GOODS

(71) Applicant: Georgia June & Co., LLC, Valdosta, GA (US)

(72) Inventors: Jerry G. Purvis, Jr., Valdosta, GA (US); John Brandon Johnson, Irvine, CA (US)

(21) Appl. No.: 14/628,298

(22) Filed: Feb. 22, 2015

Related U.S. Application Data
(60) Provisional application No. 62/005,980, filed on May 30, 2014.

(51) Int. Cl. G06Q 30/06; H04N 5/265; G06T 5/50; G06T 3/00; G06T 5/00; G06K 9/00; G06F 17/30

(52) U.S. Cl. CPC G06Q 30/0635; G06K 9/00013; H04N 5/265; G06F 17/3028; G06T 3/0093; G06Q 30/0621; G06T 5/002; G06T 5/50; G06K 2009/00953; G06T 2207/20224; G06T 2207/10024

(57) ABSTRACT

A method of digitally processing a digital image file comprising a print image and a non-print portion, in order to isolate the print image from the non-print port ion of the digital image file, comprising the steps of converting the digital image file to grayscale whereby a grayscale image is created, creating a blurred copy of the grayscale image whereby a blurred grayscale image is created, creating a composite image comprising the difference between the blurred grayscale image and the grayscale image, creating a negative image comprising the negative of the composite image, removing dithering from the negative image, resulting in a dithered image, normalizing the colorspace of the dithered image to black and white, replacing white pixels with transparent pixel information to form a processed print image, and saving the processed print image in an image file format with transparency support.

### CROSS-REFERENCE TO RELATED APPLICATIONS

This application claims priority to U.S. Provisional Application No. 62/005,980 filed 30 May 2014, the content of which is hereby incorporated by reference as if fully recited herein.

### TECHNICAL FIELD

Exemplary embodiments of the present invention relate generally to digital image capturing and processing systems and methods, and more specifically to systems and methods for digital capturing and processing of prints, and applications thereof to consumer goods.

### BACKGROUND OF THE INVENTION

Prints are often taken in association with the birth of a child, for example foot prints or hand prints. In this disclosure, references to “prints” shall generally be taken to encompass hand prints, foot prints, or any other similar type of impression or representation of the physical contours and features of a surface. For example, a print may refer to a stamp taken of a newborn child's feet, whether inkless or with ink, and is a two-dimensional representation of the size, shape and contours of the soles of that newborn's feet. Furthermore, unless stated otherwise, references to “hand prints” or “foot prints” or the like shall be interpreted to mean that the particular print mentioned is interchangeable with other types of prints, whether separately or in combination.

Prints may often be recorded in association with birth records, for instance, by hospital staff at the time of a newborn child's birth. It is also common to stamp a newborn child's feet on the father or mother's shirt or other clothing items during this time as well. However, after foot or hand prints are placed onto clothing fabric, the clothing on which the prints are placed cannot readily be laundered without degrading or destroying the prints. Thus, after initially wearing the clothing bearing the prints, it is quite common for the clothing to be stored away, without being worn again. Alternatively, the section of the clothing bearing the prints can sometimes be removed and preserved as a keepsake, for example by placing the clothing section into a frame—a process that destroys the clothing article. Sometimes the clothing may be framed without alteration.

The aforementioned steps are often taken in an effort to preserve the moment, memories of the child's birth, and the prints themselves. Other methods of creating keepsakes related to hand, foot and other prints are known that allow parents or others to create additional items outside of the hospital setting or otherwise after the birth of the child. For example, kits are available for preparing plaster molds of hands and feet. Home use ink kits are also available, enabling the parents to create framed art or multiple articles of clothing stamped with newborn prints. However, the latter kits do not address the problem of print degradation and destruction due to washing, and thus the clothing loses the prints over time. As children grow continuously, there is also no ability to create additional clothing items with the newborn's prints once the initially created items are used up and the prints are destroyed.

Furthermore, the known home stamping kits currently are cumbersome and time consuming to use, because each item—whether clothing, framed art, or the like—must be manually created. Importantly, where prints of newborn hands, feet and the like are in high demand, the child must be used to create each of the items. This often becomes difficult or is undesirable generally because of the discomfort to the child. Therefore, there exists a need in the art for systems and methods of creating birth memorabilia items bearing the prints of a newborn without requiring the newborn and parents' involvement in manually creating each item. Additionally, there is a further need of systems and methods that enable the items to be created without significant degradation or destruction of the prints themselves due to normal use of the items, for example such as due to the laundering of clothing items bearing the prints. Currently known kits also enable the physical stamping of birth memorabilia items, but do not offer the creation of such items of types that may be difficult due to size or material, for example, to stamp with prints.

It is therefore an unmet need in the prior art for a system and method that will enable the digital capturing and processing of prints, and the application of the digital representation on innumerable consumer goods, such as birth memorabilia items, without physical replication of prints requiring repeated participation of the child, pet or general surface being captured, without significant print degradation or fragility. Furthermore, there is an unmet need for a system and method that enables continual application to consumer goods long after the time of impression, eases use of the digital, processed print in connection with a large variety of such items, and the like. No known references, taken alone or in combination, are seen as teaching or suggesting the presently claimed system and method for capturing, processing and using prints of the type generally described herein.

### BRIEF SUMMARY OF THE INVENTION

Exemplary embodiments of the present disclosure pertain to methods of creating a personalized consumer good via a print processing server including the steps of: receiving a print image comprising a print and background image, receiving account information, receiving order information, creating a user account, processing the print image wherein the background image is removed and the print is isolated as a processed print, and processing the order information whereby the processed print is applied to create the personalized consumer good bearing the processed print image.

An object of the present invention is to provide exemplary method of creating a personalized consumer good including the steps of: receiving order information and account information at a capture device, creating a print, capturing a print image of the print comprising the print and background image, transmitting the account information, order information and print image to a print processing server, creating a user account on the print processing server, processing the print image wherein the background image is removed and the print is isolated as a processed print, and processing the order information whereby the processed print is applied to create the personalized consumer good wherein the processed print image is applied.

Another objection of the present invention is to provide a system for creating personalized consumer goods such as a birth memorabilia item including a stamping form or capture document having a designated print stamping location, and a print stamped on the designated print stamping location, a capture device adapted for receiving account information, order information, and a print image, and a print processing server in communication with the capture device adapted for processing the print image wherein the background image is removed and the print is isolated as a processed print, and processing the order information whereby the processed print is applied to create the birth memorabilia item.

A further object of the present invention is to provide a convenient and endurable manner of applying prints to a multitude of consumer goods. In some embodiments, a method of digitally processing a digital image file comprising a print image and a non-print portion is provided. The method may include the steps of receiving the digital image file at a print processing server, associating the digital image file with a unique identifier, isolating the print image from the non-print portion of the digital image file, creating a processed print image by saving the isolated print image in an image file format with transparency support, receiving order information comprising a consumer good selection of a consumer good on which the processed print image is to be applied and the unique identifier associated with the processed print image, and processing the order information whereby the processed print image is applied to the consumer good.

In some embodiments, the method provided further includes the steps of receiving account information at the print processing server, and associating the account information with the unique identifier. Some embodiments include storing the processed print image, unique identifier and account information after associating the account information with the unique identifier, whereby order information may be received and processed on at least two separate occasions. In yet further embodiments, the method include wherein the order information further comprises custom placement location data whereby placement of the processed print image on a surface of the consumer good identified by the consumer good selection is discernible.

Another object of the invention is to provide a method that protects privacy concerns. In some embodiments, wherein the print image was derived from a human being, the processed print image cannot be used in forensic identification methods to personally identify the human being.

In some embodiments, the image file format with transparency support is a raster graphics file format. The raster graphics file format may be a portable network graphics (PNG) format.

Other embodiments are provided that include the steps of receiving the digital image file from a user at a print processing server, receiving account information from the user comprising user information and contact information, creating a user account whereby the digital image file and the account information are associated, processing the digital image file by isolating the print image from the non-print portion of the digital image file and creating a processed print image by saving the isolated print image in an image file format with transparency support, receiving order information from the user comprising a processed print image selection identifying the processed print image and a consumer good selection comprising a consumer good selected by the user and on which the processed print image is to be applied, and processing the order information by causing the processed print image to be applied to the consumer good.

An object of the invention is also to provide ideal image processing steps, including embodiments having the steps of converting the digital image file to grayscale whereby a grayscale image is created, creating a blurred copy of the grayscale image whereby a blurred grayscale image is created, creating a composite image comprising the difference between the blurred grayscale image and the grayscale image, creating a negative image comprising the negative of the composite image, removing dithering from the negative image, resulting in a dithered image, normalizing the colorspace of the dithered image to black and white, replacing white pixels with transparent pixel information to form a processed print image, and saving the processed print image in an image file format with transparency support. In some embodiments, the blurred grayscale image is created by a y-offset blur. In some embodiments, the composite image is created as a relative component alpha differential composition with a threshold of 3%. In some embodiments, the alpha channel of the processed print image is set to Red Green Blue Alpha with a fuzz factor set to 80%. In some embodiments, the composite image is created as a relative component alpha differential composition with a threshold of between 2-8%.

It is an object of this invention to provide a system and method for capturing, processing and using prints of the type generally described herein, being adapted for the purposes set forth herein, and overcoming disadvantages found in the prior art. These and other advantages are provided by the invention described and shown in more detail below.

### BRIEF DESCRIPTION OF THE SEVERAL VIEWS OF THE DRAWINGS

Novel features and advantages of the present invention, in addition to those mentioned above, will become apparent to those skilled in the art from a reading of the following detailed description in conjunction with the accompanying drawings wherein identical reference characters refer to identical parts and in which:

FIG. 1 is a schematic diagram of an exemplary embodiment of a system for creating personalized consumer goods bearing processed print images;

FIG. 2 is a flow diagram of a first exemplary embodiment of a method of creating personalized consumer goods bearing processed print images;

FIG. 3 is a flow diagram of an exemplary embodiment of the method of processing the digital image files;

FIG. 4 is a flow diagram of a second exemplary embodiment of a method of creating personalized consumer goods bearing processed print images; and

FIG. 5 is an exemplary embodiment of an optional capture document, or print stamping form, used to capture print images.

### DETAILED DESCRIPTION OF THE INVENTION

It is common for the prints of at least the hands, feet or both of a newborn child to be taken at or near the time of birth. This process is often carried out in connection with the creation of birth records, for keepsake purposes, a combination thereof, or for any number of other desired purposes. Such prints may be taken by placing the newborn's hands or feet on an ink pad and then stamping the print onto an item by pressing the hands or feet that were in contact with the pad thereon. The item may be any type of desired item, limited only by practical or safety purposes, in that some materials, shapes and sizes of items are not amenable to stamping. In the childbirth context items typically include, for instance, documents (e.g., birth records, certificates, etc.), clothing (e.g., t-shirts), and the like. In some settings, inkless printing pads are used as an alternative to ink pads, depending upon the particular desires of the parents or hospital involved in the process, or the printing systems available at that time.

For the purposes of this disclosure, the method by which a physical print is taken/created is not considered to be limited to any particular type or manner. It is sufficient that the print creation/stamping step results in the creation of a two-dimensional representation of the size, shape and contours of a physical, three-dimensional surface from which such a print is desired—e.g., foot, hand or paw prints. Therefore, either traditional ink or inkless systems may be utilized to create the prints without limitation, as well as any other such systems now known or later developed that produce a representation as described, or those comparable thereto. For example, the stamping step may be carried out via an electronic device, wherein no ink or chemicals are needed to create a print. In some embodiments, the invented system and method may even optionally be used to create digitize old birth records of grown children or other such preexisting prints for application to consumer goods, for example.

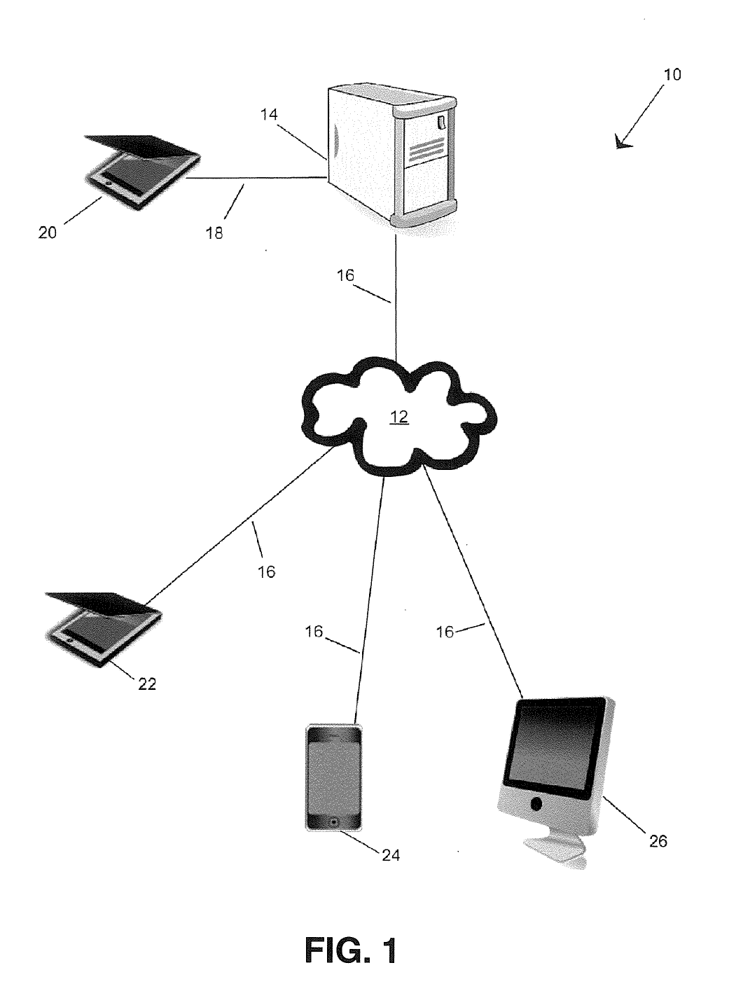

FIG. 1 is a schematic view of an exemplary embodiment of a system 10 in accordance with the invention. The various components of the system 10 may operatively be connected via a network 12, which represents any suitable means of networked communication among the system components. Depending upon the particular embodiment, the network 12 may comprise one or more data communication/network means such as private networks, the internet, wide (WAN) and local (LAN) area networks, a virtual private network (VPN), cellular or other wireless networks, digital subscriber (DSL) or other telephone line, Bluetooth connection, etc. A plurality of capture devices are depicted in communication with a print processing server 14. Communications links 16 are shown and generally represent data/communication connections of types corresponding to the particular network 12 composition chosen for a given implementation, and may represent the combination of several physical links or protocols. For example, the data links 16 may represent one or more wired or wireless connections such as a WiFi, Bluetooth, telephone, Ethernet, 3G, LTE, optical fiber, satellite, cable, T1, T3 or other such link appropriate to carry out communication via the network configurations chosen. Communication link 18 represents a direct (e.g., intra-network, parallel port, USB, etc.) connection between a capture device 20 and the print processing server. Direct connection of a capture device 20, such as a flatbed scanner, may be desired in order to receive physical prints created during the stamping step and mailed to the administrator of the print processing server. This would be useful for applications of the invention in locations that do not have access to appropriate capture devices, those having poor connectivity, or the like. Such a configuration may be employed, for instance, in hospitals or animal shelters.

The print processing server 14 is also operatively connected to the network 12 via a communication link 16. For the purposes of this disclosure, a “print processing server” is defined as a computing device or group of such devices programmed and configured to carry out the print image capturing, processing or application activities as further described herein. It can be embodied in a single computing device, such as a desktop or laptop computer, a single server or scalable rack server system, or the like. It may also be embodied as a group of networked servers, for instance, and may include one or more databases, database servers, payment processing gateways, and the like. Although the print processing server 14 depicted in connection with FIG. 1 is shown as a single computing device, it will be understood that the server 14 may comprise multiple devices operating together, and that to avoid confusion, this disclosure does not describe in detail the structures or equivalents known to those skilled in the art for performing some of the sub-functions described herein. In general, the meaning of the term print processing server is meant to encompass one or more computing devices generally including input/output means, memory, data storage or generally a combination thereof suitable for the purposes described herein in view of a particular application, one or more processors, and executable software code or routines programmed and stored within its data storage means or on computer-readable media, or on a second networked device accessible to the print processing server, or a combination thereof.

Capture devices may be employed to capture an image of a foot, hand or paw print after the print is created, for example by stamping on a sheet of paper. The paper—or capture document—may include additional information if desired, such as ID numbers or account information.

Physical prints, such as hand, foot or paw prints, are created during the print creation/stamping step. The invention includes the step of capturing the print image, for example by optical scanning or digital photograph. The form of print image capture may vary depending upon technological and practical considerations present in a particular application of the disclosed invention. Generally, a print may be captured by way of a capture device. A “capture device” for the purposes of this disclosure means an electronic device having image capture functionality (e.g., flatbed or other optical scanner, digital camera), or that is generally capable of creating a two-dimensional digital representation of a three-dimensional surface. It is optional but preferred that the capture device be implemented on a computing devices having input/output means, memory, data storage or generally a combination thereof suitable for the purposes described herein in view of a particular application, image capture functionality, and one or more processors.

Capture devices may thus include, without limitation, mobile phones, personal computers, tablets, laptops, kiosks, mainframe access terminals, servers, secureprint tablet devices, such as those utilized in the banking industry, private business sectors, and law enforcement, and other like devices. In some embodiments, the capture device may include additional functionality disclosed herein by way of executable software code or routines programmed and stored within its data storage means or on computer-readable media, on a second networked device accessed by the capture device, such as a print processing server, by execution of instructions received remotely, or a combination thereof. Some optional functions of the capture device described herein, such as accepting payment, may be carried out by way of periphery device, such as a card reader, for instance, if desired. Simple image capture devices may alternatively be equipped only with image capture functionality and output means.

Returning to FIG. 1, two simple capture devices 20, 22 are depicted as scanners. The external capture device 22 is used to create a digital image of one or more physical prints (“print image(s)”), such as when initially created/stamped upon a blank sheet of paper or preprinted form/capture document, and transmit the unprocessed print image via the network 12 to the print processing server 14. The external capture device 22 may transmit the image directly, via communication link 16, or indirectly by way of connection to another computing device (e.g., by upload through a web browser after image capture). The internal capture device 20 serves the same purpose, but is used by the print processing server 14 administrator to process prints received in hard copy form, for example via the postal service. In some embodiments, the print processing server 14 may be deployed as software installed at numerous point-of-sale computer systems, such as directly at a hospital or animal shelter, for instance. In those cases, the invented steps may be performed at the point of sale.

Additional functionality is preferably enabled by the use of a smart capture device, such as devices 24 or 26 for instance. In some embodiments, these types of devices will generally include at least image capture functionality, such as digital camera features commonly found in smart phones, tablets and some personal computers. For example, a personal computer 26 may be employed in connection with a kit available at retail stores or hospital gift shops. Users may purchase the kit, optionally provided with stamping equipment and stamping forms/capture documents, which are scanned/digitally photographed and transmitted to the print processing server 14 via the personal computer 26. Order and/or account information may be optionally transmitted to the print processing server via the form, a web interface accessible by the personal computer 26, or a combination thereof. Other features will be described in further detail in connection with exemplary embodiments of the invention below.

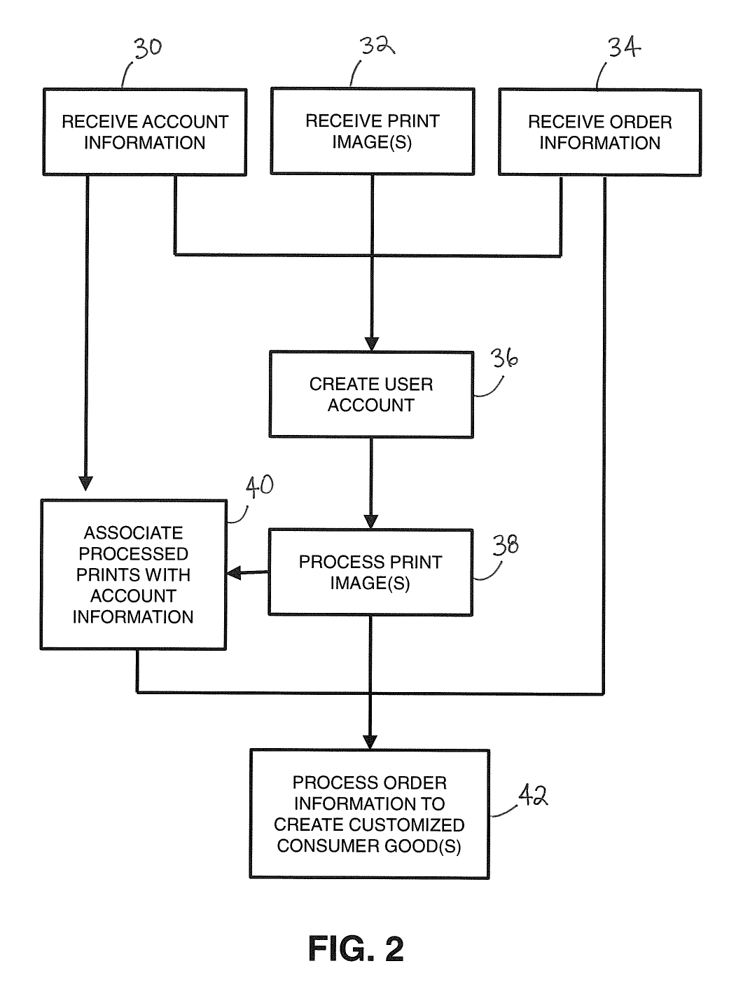

The steps of an exemplary embodiment of the invention are provided generally in connection with the flow diagram depicted in FIG. 2. The order of the steps is not necessarily considered to be limiting to the claimed invention, unless expressly provided otherwise herein, or a particular order is evident from the description. As will be evident from this disclosure, several exemplary embodiments may implement the steps of the invention in various orders.

An exemplary method as depicted in FIG. 2 involves the receipt, by the print processing server, of at least three things: account information; one or more print images in one or more digital image files; and order information. Account information is received at 30 by the print processing server and includes identifying information for the person(s), newborn, pet, combination thereof, and the like. Identifying information may include information such as but not limited to patient contact information, parental and newborn names, address, birthdates, and the like. Account information may further include such items as payment information, if payment information is to be stored along with account information for use in future purchases.

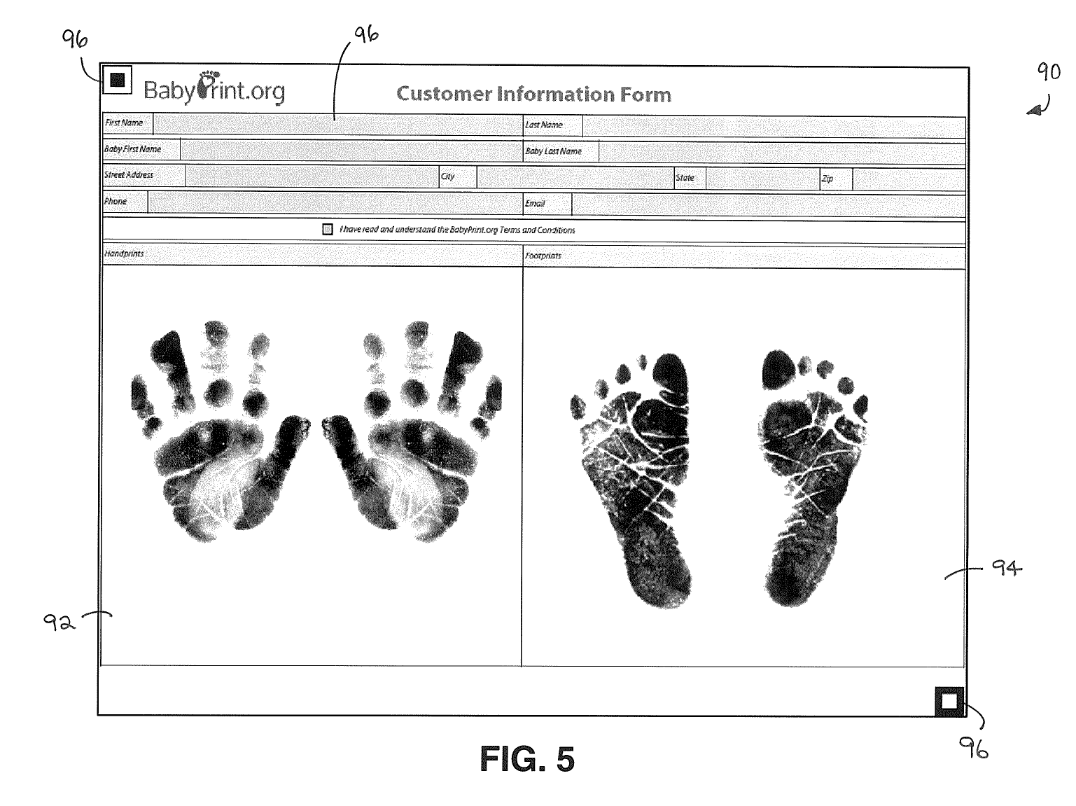

The images of the one or more prints created are received by the print processing server at 32. The print images may generally be captured by a capture device, as described above. A print image is the portion of a digital image file corresponding to a print created on a print surface, such as a sheet of paper generally or a prepared capture document (see, e.g., FIG. 5).

Order information is received by the print processing server at 34. The order information may include a selection of one or more consumer goods such as birth memorabilia items, item numbers and quantities desired by the parents, family members, customer, etc. Optional order information includes custom placement instructions in relation to the placement of the processed prints on the consumer goods chosen, for example a selection chosen from several available options, or a more robust custom placement via the use of a web-available software interface. In some embodiments, one consumer good may be included within the charges of a hospital stay or a pet adoption, for instance, or given free of charge. In others, payment may be required based upon the costs listed for various consumer goods. Payment information may or may not be included in the order information as previously discussed.

The receipt of the print images at 32 prompts the creation of the user account at 36, in that any print images received by the print processing server are associated with a unique ID. The print processing server then proceeds to implement filter routines to process the print image, isolating the prints from any background information, as at 38. Preferably, a transparent digital file (e.g., a portable network graphic or .png file) is created as a result, and embodies the processed print.

Returning to the creation of the user account at 36, the unique ID, customer ID or other such access items such as a cryptographic password may be communicated to the user. In some embodiments, if the account information and print images were received at the same time, the access items may be communicated to the user via contact information provided as part of the account information, such as an email address or via mail or SMS text. In other embodiments in which a smart capture device is used (e.g., 24 or 26 in FIG. 1), the access items may be transmitted back to the smart device for display to the user.

In some embodiments, the receipt of the account information at 30 may optionally occur at a time after the user account creation step at 36. For example, the print images are received at 32, a user account is created at 36 whereby access items are communicated to the user, and the print images are processed at 38. Under these circumstances, the user may wish to provide account information at a later time, for instance after returning home from the hospital. At 30, the print processing server receives the account information and proceeds to associate the account information with the processed prints at 40. In some embodiments, the account information received at 30 includes the access items and may be received by the print processing server via a website interface, for instance. In other embodiments, the account information received at 30 may be received by the print processing server in physical form, for instance via a printed form mailed to the print processor. In the latter case, a print image is created, for example via an internal capture device (20 in FIG. 1). Regardless of the manner of receipt at 30, if occurring after user account creation at 36, the print processing server then uses the access items to associate the user account and processed prints with the account information, as at 40.

By way of further example, a pet adoption could include the provision of access items such as a unique ID and temporary password at the time of adoption. The adoption agency may optionally perform the print stamping step whereby physical paw prints are created, prior to the adoption, capture the prints to create a print image, and upload the print image to a print processing server at step 32. The print processing server may then create the user account at step 36, and communication the auto-generated unique ID and temporary password back to the adoption agency, which is turn provides the access items to the new pet owner at the time of the adoption, as previously mentioned. The provision of the access items to the new pet owner may also include instructions for accessing the processed print images, for example via the inclusion of a URL or web address. After adoption, the new pet owners may visit a website, authenticate using the access items received from the adoption agency, and transmit account information to the print processing server as at step 30. Thereafter, the print processing server associates the processed print images with the account information, as at step 40.

Proceeding to 42, the print processing server applies the order information received at 34, the digital files containing the prints processed at 38, and the account information received at 30, to create one or more customized consumer goods bearing images of the processed print images thereon. This step may include transmitting custom order information to a manufacturer for fulfillment, for instance. In some embodiments, order history, payment information, processed prints, or a combination thereof are stored with the user account to allow users to return at a future time and easily place additional orders. It is preferred that processed prints be stored indefinitely at the request of the user, or by default.

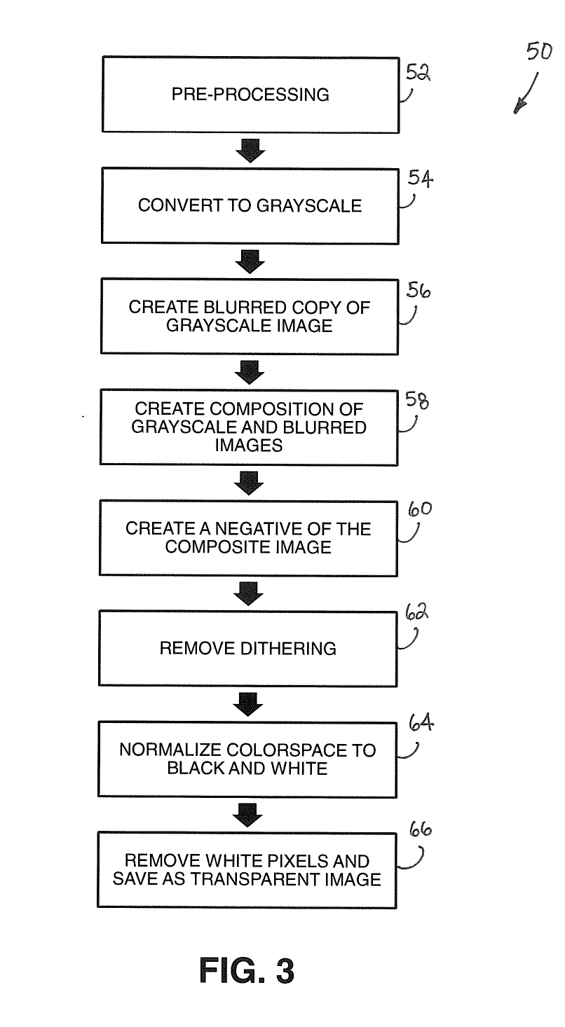

An exemplary method 50 of, as in step 38, processing a print image received by the print processing server at step 32, is described in connection with FIG. 3. The convenience provided by the implementation of the instant invention in the capture, processing and application of prints also presents several obstacles to overcome. One of the objectives is to provide nearly limitless print image capture techniques to users, and the print processing steps themselves can further this objective. For example, where capture devices such as a digital camera on a mobile phone (e.g., 24 in FIG. 1) are used, the initial, unprocessed print images received by the print processing server (e.g., at step 32 in FIG. 2) often present large gradients of gray in the background of the print image. This is often due to lighting problems, such as inconsistent light source origination points/directions and intensity, for example, or generally by the large spectrum of available capture devices that may be utilized by users. The unpredictability of light source intensity and camera quality from one print image to the next, for instance, makes it impractical or impossible to use a global threshold extraction of gray background removal. Typically, but not exclusively, the print images received at step 32 are in JPG file format, and have no alpha transparency characteristic.

Furthermore, there are several considerations that have been found to improve the processing steps of the invention, such as minimizing processed print image file size without negatively affecting image quality. Additionally, it has been found that the quality of the processed print image, in sharpness and resolution, for example, is important to the aesthetic value of the customized consumer goods ultimately created using the inventive process. However—particularly in the case of young children—it has been found that it is preferable for the processed print images not to have the potential to negatively impact privacy of the subject of the print (where the subject is a person). Essentially, the quality of the processed print images should not be sufficient for finger print identification of the subject of the print.

With these considerations developed, preferable embodiments of the invention utilize the following steps (shown generally as method 50 in FIG. 3) during the print processing step 32 shown in FIG. 2. Beginning as step 52, pre-processing actions are performed as necessary in a given application. Pre-processing actions can include, for example, print image orientation, marker location (see, e.g., capture document 90 shown in connection with FIG. 5), and cropping of the original full-size digital image. Then, at step 54, the image is converted to grayscale. In order to maintain a sufficiently high level of quality in the resulting processed print image without retaining detail sufficient for use in identification of the print subject, the following steps are considered preferred. At 56, a blurred copy of the grayscale image is generated. In some embodiments, the blur is created using a 0×20 x-y scale blur. Then, at step 58, a composition image is created of the difference of the grayscale and blurred images. In some preferred embodiments, this is carried out using a relative component alpha differential threshold of 3%.

Next, a negative of the composite image created in step 58 is created at step 60. Dithering is removed at step 62, and the colorspace is normalized to black and white at step 64. White pixels are then removed from the image at step 66, and the image is saved in a file format with alpha transparency, preferably but not limited to the PNG file format. The resulting processed print image may now be applied to various customizable consumer goods in an aesthetically pleasing manner, such as apparel, coffee mugs, baby items, pet items, and the like.

Preferred embodiments of the previously described method 50 are carried out using the Linux-based ImageMagick graphics processing library. Although those skilled in the art will appreciate that other libraries, operating systems, syntax and operations may be utilized according to and without departing from the scope of the present invention, the following commands are illustrative of a preferred embodiment of the image processing steps:
$cmd=“;
$cmd .=‘convert’ . $infile . ‘(-clone 0 -crop’.$w.‘x’.$h.‘+’.$x.‘+’.$y.‘-colorspace Gray -alpha off)’;
$cmd .=‘(-clone 1 -blur 0×20)’;
$cmd .=‘(-clone 1,2 -compose minus_dst -composite -threshold 3%)’;
$cmd .=‘(-clone 3 -negate+dither -colorspace gray -colors 2 -normalize)’;
$cmd .=‘-delete 0-3 ’ . $tmpfile . ‘&&’;
$cmd .=‘convert’ . $tmpfile . ‘-bordercolor white -border 1×1 -alpha set -channel RGBA -fuzz 80% -fill none -floodfill +0+0 white -shave 1×1’ . $outfile; exec($cmd);

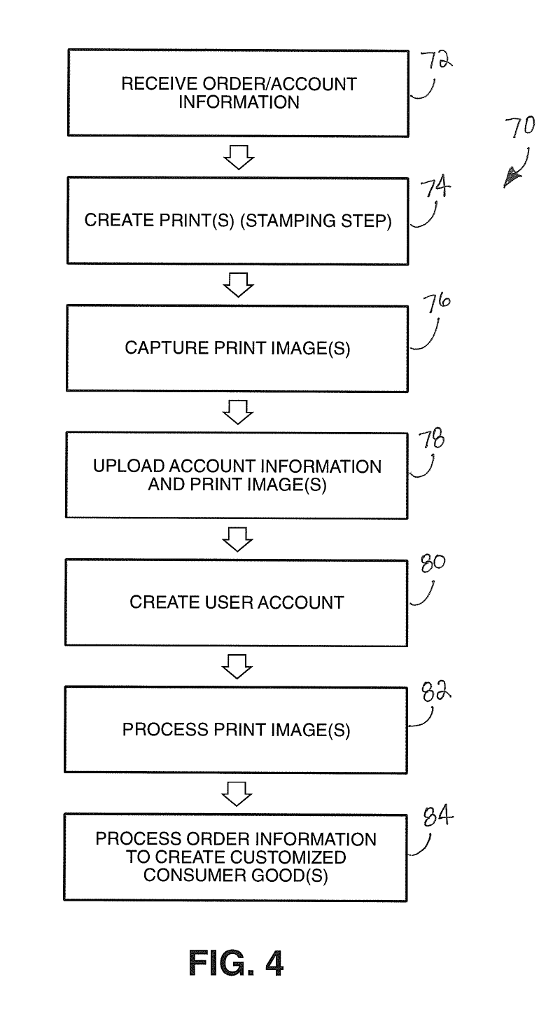

A further exemplary method 70 associated with the invention is depicted in the flow diagram shown in FIG. 4 configured for preferred use in a hospital at and around the time of birth. At 72, order information is received from a user, preferably via a smart capture device such as a tablet (e.g., hospital provided or user-owned). Application software may be provided by a hospital for download in the latter case, for example. The capture device may be provided to the user either before or after birth, and may contain a list of consumer goods such as birth memorabilia that are available for purchase and customization in connection with the processed prints.

After the birth, prints are created at 74 by stamping the newborn's feet, hands, etc. by any manner desired onto a sheet of clean paper, or a form/capture document having designated print stamping locations (see FIG. 5) for example. A capture device is then used to capture the print images at 76. In preferred embodiments, the tablet or other such electronic device on which the order information was received at 72 is used to take a digital photograph of the prints created in the previous step 74, at 76.

At 78, the capture device receives account information (optionally provided with the order information at 72) and uploads the order information, print images and account information to the print processing server. The print processing server then proceeds to create a user account at 80 whereby the information received from the capture device is associated with a customer ID. Access items may optionally be provided to the user at this step as well, to enable later access to the account, for example via the web or telephone, as described previously herein.

The print processing server proceeds at 82 to process the print images received at step 78 whereby filter routines are implemented to process the print image, thereby isolating the prints from any background information (as described in connection with the steps of FIG. 3, for example). Preferably, a transparent digital file (e.g., a portable network graphic or PNG file) is created as a result, and embodies the processed print. The processed prints are then combined with the order information at 84 to facilitate order fulfillment for one or more birth memorabilia items.

Turning to FIG. 5, an exemplary form is shown for use in connection with the print creation/stamping process. While such a step is optional, such as in the case wherein old birth records are utilized to create birth memorabilia items at a time after the birth has taken place, preferred embodiments implemented in hospitals or via retail kits may optionally make use of such forms. The capture document 90 include one or more designated print stamping locations 92, 94, for example an area for hand prints 92 and an area for foot prints 94. Other account information fields 96 may be provided as well, and may be populated with printed information entered into a capture device (e.g., at 72 in embodiments such as described in connection with FIG. 4), or in handwritten form. A capture device may then be used to capture an image of the prints and form information to be transmitted to the print processing server as previously described. The use of one or more optional orientation markers 96 on such exemplary prepared capture documents 90 are shown as well, for use in pre-processing activity as described in connection with step 52 in FIGS. 3.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A method of digitally processing a digital image file comprising a print image and a non-print portion, the method comprising the steps of:
receiving the digital image file at a print processing server;
associating the digital image file with a unique identifier;
isolating the print image from the non-print portion of the digital image file;
creating a processed print image by saving the isolated print image in an image file format with transparency support;
receiving order information comprising:
a consumer good selection of a consumer good on which the processed print image is to be applied; and
the unique identifier associated with the processed print image; and
processing the order information whereby the processed print image is applied to the consumer good.

2. The method of claim 1, further comprising the steps of:
receiving account information at the print processing server; and
associating the account information with the unique identifier.

3. The method of claim 2, further comprising the steps of:
storing the processed print image, unique identifier and account information after associating the account information with the unique identifier, whereby order information may be received and processed on at least two separate occasions.

4. The method of claim 1, wherein the order information further comprises:
custom placement location data whereby placement of the processed print image on a surface of the consumer good identified by the consumer good selection is discernible.

5. The method of claim 1, wherein the print image was derived from a human being, the processed print image cannot be used in forensic identification methods to personally identify the human being.

6. The method of claim 1, wherein the image file format with transparency support is a raster graphics file format.

7. The method of claim 6, wherein the raster graphics file format is a portable network graphics (PNG) format.

8. A method of digitally processing a digital image file comprising a print image and a non-print portion, the method comprising the steps of:
receiving the digital image file from a user at a print processing server;
receiving account information from the user comprising:
user information; and
contact information;
creating a user account whereby the digital image file and the account information are associated;
processing the digital image file by:
isolating the print image from the non-print portion of the digital image file; and
creating a processed print image by saving the isolated print image in an image file format with transparency support;
receiving order information from the user comprising:
a processed print image selection identifying the processed print image; and
a consumer good selection comprising a consumer good selected by the user and on which the processed print image is to be applied; and
processing the order information by causing the processed print image to be applied to the consumer good.

9. The method of claim 8, wherein the order information further comprises:
custom placement location data whereby placement of the processed print image on a surface of the consumer good identified by the consumer good selection is discernible.

10. The method of claim 8, wherein the print image was derived from a human being, the processed print image cannot be used in forensic identification methods to personally identify the human being.

11. The method of claim 8, wherein the step of processing the digital image file comprises the steps of:
converting the digital image file to grayscale whereby a grayscale image is created;
creating a blurred copy of the grayscale image whereby a blurred grayscale image is created;
creating a composite image comprising the difference between the blurred grayscale image and the grayscale image;
creating a negative image comprising the negative of the composite image;
removing dithering from the negative image, resulting in a dithered image;
normalizing the colorspace of the dithered image to black and white;
replacing white pixels with transparent pixel information to form a processed print image; and
saving the processed print image in an image file format with transparency support.

12. The method of claim 8, wherein the image file format with transparency support is a raster graphics file format.

13. The method of claim 12, wherein the raster graphics file format is a portable network graphics (PNG) format.

14. The method of claim 11, wherein the blurred grayscale image is created by a y-offset blur.

15. The method of claim 11, wherein the composite image is created as a relative component alpha differential composition with a threshold of 3%.

16. The method of claim 13, wherein the alpha channel of the processed print image is set to Red Green Blue Alpha with a fuzz factor set to 80%.

17. A method of digitally processing a digital image file comprising a print image and a non-print portion, in order to isolate the print image from the non-print port ion of the digital image file, the method comprising the steps of:
converting the digital image file to grayscale whereby a grayscale image is created;
creating a blurred copy of the grayscale image whereby a blurred grayscale image is created;
creating a composite image comprising the difference between the blurred grayscale image and the grayscale image;
creating a negative image comprising the negative of the composite image;
removing dithering from the negative image, resulting in a dithered image;
normalizing the colorspace of the dithered image to black and white;
replacing white pixels with transparent pixel information to form a processed print image; and
saving the processed print image in an image file format with transparency support.

18. The method of claim 17, wherein the composite image is created as a relative component alpha differential composition with a threshold of between 2-8%.
